(19) United States
(12) Patent Application Publication
(10) Pub. No.: US 2024/0079567 A1
(43) Pub. Date: Mar. 7, 2024

(54) ACTIVE MATERIAL COMPOSITE PARTICLE, ELECTRODE, SECONDARY BATTERY, AND MANUFACTURING METHOD FOR ACTIVE MATERIAL COMPOSITE PARTICLE

(71) Applicant: TOYOTA JIDOSHA KABUSHIKI KAISHA, Toyota-shi (JP)

(72) Inventors: Hideaki NISHIMURA, Sunto-gun (JP); Shinji NAKANISHI, Mishima-shi (JP)

(73) Assignee: TOYOTA JIDOSHA KABUSHIKI KAISHA, Toyota-shi (JP)

(21) Appl. No.: 18/457,930

(22) Filed: Aug. 29, 2023

(30) Foreign Application Priority Data
Aug. 31, 2022 (JP) 2022-138004

(51) Int. Cl. H01M 4/36; H01M 4/60; H01M 10/0562

(52) U.S. Cl. CPC H01M 4/366; H01M 4/602; H01M 10/0562; H01M 2004/027

(57) ABSTRACT

Disclosed is an active material composite particle comprising Si and having excellent cycle characteristics. The active material composite particle of the present disclosure comprises a center portion and a surface layer portion, wherein the center portion comprises a solid electrolyte and a plurality of Si particles, the surface layer portion comprises a polymer and has a carrier ion-conductivity, and a ratio of polymer in the surface layer portion is higher than a ratio of polymer in the center portion.

### FIELD

The present application discloses an active material composite particle, an electrode, a secondary battery, and a manufacturing method for an active material composite particle.

### BACKGROUND

PTL 1 discloses a granulated particle of a negative electrode active material, comprising a composite of Si and carbon and a binder. PTL 2 discloses a negative electrode active material powder, comprising secondary particles of a Si-based active material and a fluorinated layer provided on surfaces of the secondary particles.

### CITATION LIST

### Patent Literature

[PTL 1] Japanese Unexamined Patent Publication No. 2019-021571
[PTL 2] Japanese Unexamined Patent Publication No. 2021-057216

### SUMMARY

### Technical Problem

Active materials comprising Si can be improved in terms of cycle characteristics.

### Solution to Problem

The present application discloses the following aspects as means for solution to the above problem.

### <Aspect 1>

An active material composite particle, comprising a center portion and a surface layer portion, wherein
the center portion comprises a solid electrolyte and a plurality of Si particles,
the surface layer portion comprises a polymer and has a carrier ion-conductivity, and
a ratio of polymer in the surface layer portion is higher than a ratio of polymer in the center portion.

### <Aspect 2>

The active material composite particle according to Aspect 1, wherein
carrier ion conductivity of the solid electrolyte is higher than carrier ion conductivity of the surface layer portion.

### <Aspect 3>

The active material composite particle according to Aspect 1 or 2, wherein
the solid electrolyte comprises a sulfide solid electrolyte.

### <Aspect 4>

The active material composite particle according to any of Aspects 1 to 3, wherein
the surface layer portion comprises a salt, and
the salt comprises a carrier ion.

### <Aspect 5>

The active material composite particle according to any of Aspects 1 to 4, wherein
a ratio of Si particles in the center portion is higher than a ratio of Si particles in the surface layer portion.

### <Aspect 6>

The active material composite particle according to any of Aspects 1 to 5, wherein
a ratio of solid electrolyte in the center portion is higher than a ratio of solid electrolyte in the surface layer portion.

### <Aspect 7>

An electrode comprising the active material composite particle according to any of Aspects 1 to 6.

### <Aspect 8>

The electrode according to Aspect 7, comprising a solid electrolyte disposed around the active material composite particle.

### <Aspect 9>

A secondary battery, comprising a positive electrode, an electrolyte layer, and a negative electrode, wherein
the negative electrode comprises the active material composite particle according to any of Aspects 1 to 6.

### <Aspect 10>

The secondary battery according to Aspect 9, wherein
the negative electrode comprises a solid electrolyte disposed around the active material composite particle.

### <Aspect 11>

The secondary battery according to Aspect 9 or 10, wherein
the electrolyte layer comprises a solid electrolyte.

### <Aspect 12>

A manufacturing method for an active material composite particle, the method comprising:
mixing a solid electrolyte and a plurality of Si particles together to obtain an intermediate composite particle; and
coating a periphery of the intermediate composite particle with a material comprising a polymer and having a carrier ion-conductivity.

### Effects

The active material composite particle of the present disclosure has excellent cycle characteristics.

### BRIEF DESCRIPTION OF DRAWINGS

FIG. 1A schematically shows an example of a cross-section of the active material composite particle.

FIG. 1B is a schematic drawing for explaining a “surface layer portion” and a “center portion” in a cross-section of the active material composite particle.

FIG. 2 schematically shows an example of a configuration of a secondary battery.

FIG. 3 shows an example of the flow of a manufacturing method for the active material composite particle.

### DESCRIPTION OF EMBODIMENTS

### 1. Active Material Composite Particle

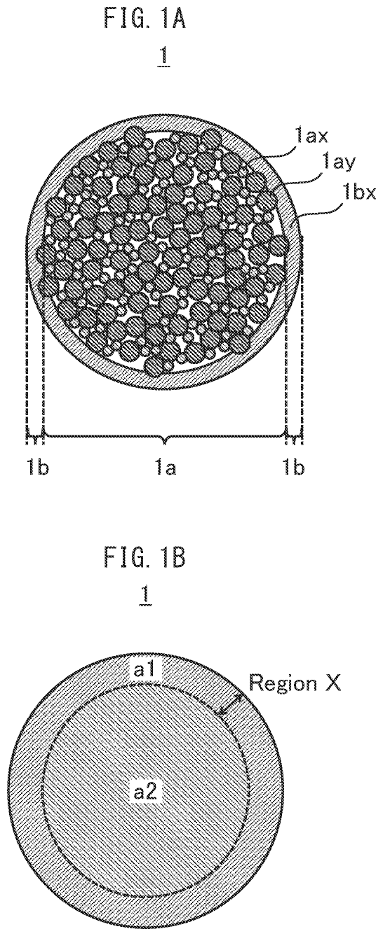

FIG. 1A schematically shows a cross-sectional structure of an active material composite particle 1 according to one embodiment. The active material composite particle 1 comprises a center portion 1a and a surface layer portion 1b. The center portion 1a comprises a solid electrolyte 1ax and a plurality of Si particles 1ay. The surface layer portion 1b comprises a polymer 1bx and has a carrier ion-conductivity. The ratio of polymer 1bx in the surface layer portion 1b is higher than the ratio of polymer in the center portion 1a.

### 1.1 Differentiation Between Center Portion and Surface Layer Portion

In the present application, the “center portion” and “surface layer portion” of the active material composite particle are defined as follows. Specifically, when a cross-section of the active material composite particle 1 is observed, if a boundary (in addition to a boundary visually confirmed by image observation, a boundary confirmed by elemental analysis may be used) is observed between the polymer-rich outermost layer and a layer on the inside thereof, the outermost layer on the outside of the boundary is regarded as the surface layer portion 1b, and the inside (inner portion) of the boundary as the center portion 1a. When a cross-section of the active material composite particle 1 is observed, and if no clear boundary is observed between the surface layer portion 1b and the center portion 1a on the inside thereof, the surface layer portion 1b and the center portion 1a are differentiated as follows. Specifically, the surface layer portion 1b of the active material composite particle 1 is specified as follows. As shown in FIG. 1B, a cross-section of the active material composite particle is observed with a scanning electron microscope (SEM) or a transmission electron microscope (TEM) and a two-dimensional image of the cross-section of the active material composite particle is acquired. When the area of a region X from the surface of the active material composite particle to a predetermined depth in the two-dimensional image is designated as a1 and the area of the entire particle as a1+a2, the region X where a1/(a1+a2) is 0.01 is regarded as the “surface layer portion of the active material composite particle”. A portion deeper than the “surface layer portion of the active material composite particle” (portion on the inside) specified in this manner is the “center portion of the active material composite particle”.

### 1.2 Ratio of Polymer in Each of Center Portion and Surface Layer Portion

In the active material composite particle 1, the surface layer portion 1b comprises a polymer 1bx, while the center portion 1a may or may not comprise a polymer. The ratio of polymer 1bx in the surface layer portion 1b is higher than the ratio of polymer in the center portion 1a. When the center portion 1a does not comprise a polymer, the ratio of polymer 1bx in the surface layer portion 1b is naturally higher than the ratio of polymer in the center portion 1a. The volume ratio VR₁ of polymer in the center portion 1a of the active material composite particle 1 may be less than 50% by volume, 40% by volume or less, 30% by volume or less, 20% by volume or less, or 10% by volume or less. The lower limit of VR₁ is not particularly limited. VR₁ may be 0% by volume or greater. In addition, the volume ratio VR₂ of polymer 1bx in the surface layer portion 1b of the active material composite particle 1 may be 50% by volume or greater, 60% by volume or greater, 70% by volume or greater, or 80% by volume or greater. The upper limit of VR₂ is not particularly limited. VR₂ may be 100% by volume or less, less than 100% by volume, 95% by volume or less, or 90% by volume or less. Further, the ratio VR₁/VR₂ of the volume ratio VR₁ of polymer in the center portion 1a of the active material composite particle 1 to the volume ratio VR₂ of polymer 1bx in the surface layer portion 1b of the composite particle 1 is not particularly limited. For example, the ratio VR₁/VR₂ may be less than 1.0, 0.9 or less, 0.8 or less, 0.7 or less, 0.6 or less, 0.5 or less, 0.4 or less, 0.3 or less, 0.2 or less, or 0.1 or less. The lower limit of the ratio VR₁/VR₂ is not particularly limited, and VR₁ can be 0% by volume as described above.

As such, since the ratio of polymer 1bx in the surface layer portion 1b of the composite particle 1 is higher than the ratio of polymer in the center portion 1a, even when Si expands due to charging, the volume change of the composite particle 1 as a whole is moderated by the polymer 1bx in the surface layer portion 1b, and the shape of the composite particle 1 as a whole is easily maintained. In addition, since the ratio of polymer 1bx in the surface layer portion 1b is high, even when Si expands due to charging, the polymer 1bx in the surface layer portion 1b functions as a cushioning material, and cracks and gaps in the material surrounding the composite particle 1 are less likely to occur. Thus, according to the active material composite particle 1, excellent cycle characteristics are easily exhibited.

The ratio of polymer in the center portion 1a of the active material composite particle 1 and the ratio of polymer 1bx in the surface layer portion 1b of the composite particle 1 may be compared as a “volume ratio” described above or as an “area ratio” in a particle cross-section. For example, the area ratio of polymer in the cross-section can be determined by carrying out an elemental analysis of a cross-section of the composite particle 1 by EDX and identifying the region where the polymer is present in the cross-section. In each of the cross-sections of the center portion 1a and the surface layer portion 1b, by determining the area ratio of the polymer, it is possible to specify whether or not the ratio of polymer 1bx in the surface layer portion 1b is higher than the ratio of polymer in the center portion 1a.

### 1.3 Ratio of Si Particles in Each of Center Portion and Surface Layer Portion

In the active material composite particle 1, the center portion 1a comprises a plurality of Si particles 1ay, while the surface layer portion 1b may or may not comprise Si particles. The ratio of Si particles 1ay in the center portion 1a may be higher than the ratio of Si particles in the surface layer portion 1b. Specifically, the active material composite particle 1 may have a Si-rich portion in the center portion 1a. When the surface layer portion 1b does not comprise Si particles, the ratio of Si particles 1ay in the center portion 1a is naturally higher than the ratio of Si particles in the surface layer portion 1b. The volume ratio VR₃ of Si particles 1ay in the center portion 1a of the active material composite particle 1 may be 50% by volume or greater, 60% by volume or greater, 70% by volume or greater, 80% by volume or greater, or 85% by volume or greater. The upper limit of VR₃ is not particularly limited. VR₃ may be, for example, less than 100% by volume, 98% by volume or less, 96% by volume or less, 94% by volume or less, or 92% by volume or less. In addition, the volume ratio VR₄ of Si particles in the surface layer portion 1b of the active material composite particle 1 may be less than 50% by volume, 40% by volume or less, 30% by volume or less, 20% by volume or less, or 10% by volume or less. The lower limit of VR₄ is not particularly limited. VR₄ may be 0% by volume or greater. Further, the ratio VR₃/VR₄ of the volume ratio VR₃ of Si particles 1ay in the center portion 1a of the active material composite particle 1 to the volume ratio VR₄ of Si particles in the surface layer portion 1b of the active material composite particle 1 is not particularly limited. For example, the ratio VR₃/VR₄ may be greater than 1.0, 1.5 or greater, 2.0 or greater, 2.5 or greater, 3.0 or greater, 3.5 or greater, 4.0 or greater, 4.5 or greater, or 5.0 or greater. The upper limit of the ratio VR₃/VR₄ is not particularly limited, and VR₄ can be 0% by volume as described above.

As such, since the ratio of Si particles 1ay in the center portion 1a of the composite particle 1 is higher than the ratio of Si particles in the surface layer portion 1b, even when the Si particles expand due to charging, expansion of the Si particles does not easily reach the outer portion of the composite particle 1, the volume change of the composite particle 1 as a whole is moderated, and the shape of the composite particle 1 as a whole is easily maintained. In addition, since the volume change of the composite particle 1 as a whole is moderated, cracks and gaps in the material surrounding the composite particle 1 are less likely to occur. Thus, according to such an active material composite particle 1, more excellent cycle characteristics are easily exhibited.

The ratio of Si particles 1ay in the center portion 1a of the active material composite particle 1 and the ratio of Si particles in the surface layer portion 1b of the composite particle 1 may be compared as a “volume ratio” described above or as an “area ratio” in a particle cross-section. For example, the area ratio of Si particles in the cross-section can be determined by carrying out an elemental analysis of a cross-section of the composite particle 1 by EDX and identifying the region where the Si particles are present in the cross-section. In each of the cross-sections of the center portion 1a and the surface layer portion 1b, by determining the area ratio of the Si particles, it is possible to specify whether or not the ratio of Si particles 1ay in the center portion 1a is higher than the ratio of Si particles in the surface layer portion 1b.

### 1.4 Ratio of Solid Electrolyte in Each of Center Portion or Surface Layer Portion

In the active material composite particle 1, the center portion 1a comprises a solid electrolyte 1ax, while the surface layer portion 1b may or may not comprise a solid electrolyte. The ratio of solid electrolyte 1ax in the center portion 1a may be higher than the ratio of solid electrolyte in the surface layer portion 1b. When the surface layer portion 1b does not comprise a solid electrolyte, the ratio of solid electrolyte 1ax in the center portion 1a is naturally higher than the ratio of solid electrolyte in the surface layer portion 1b. The volume ratio VR₅ of solid electrolyte 1ax in the center portion 1a of the active material composite particle 1 may be less than 50% by volume, 40% by volume or less, 30% by volume or less, 20% by volume or less, or 10% by volume or less. The lower limit of VR₅ is not particularly limited. VR₅ may be greater than 0% by volume, 1% by volume or greater, 3% by volume or greater, or 5% by volume or greater. In addition, the volume ratio VR₆ of solid electrolyte in the surface layer portion 1b of the active material composite particle 1 may be less than 50% by volume, 40% by volume or less, 30% by volume or less, 20% by volume or less, 10% by volume or less, or 5% by volume or less. The lower limit of VR₆ is not particularly limited. VR₆ may be 0% by volume or greater. Further, the ratio VR₅/VR₆ of the volume ratio VR₅ of solid electrolyte in the center portion 1a of the active material composite particle 1 to the volume ratio VR₆ of solid electrolyte in the surface layer portion 1b of the composite particle 1 is not particularly limited. For example, the ratio VR₅/VR₆ may be greater than 1.0, 1.5 or greater, 2.0 or greater, 2.5 or greater, 3.0 or greater, 3.5 or greater, 4.0 or greater, 4.5 or greater, or 5.0 or greater. The upper limit of the ratio VR₅/VR₆ is not particularly limited, and VR₆ can be 0% by volume as described above.

As such, since the ratio of solid electrolyte 1ax in the center portion 1a of the composite particle 1 is higher than the ratio of solid electrolyte in the surface layer portion 1b, the carrier ion-conducting property of the center portion 1a can be further enhanced, reaction nonuniformity at the inner portions of Si particles in the center portion 1a can be further suppressed, and cracking of Si particles associated with charging and discharging can be further suppressed. Thus, according to such an active material composite particle 1, more excellent cycle characteristics are easily exhibited.

The ratio of solid electrolyte 1ax in the center portion 1a of the active material composite particle 1 and the ratio of solid electrolyte in the surface layer portion 1b of the composite particle 1 may be compared as a “volume ratio” described above or as an “area ratio” in a particle cross-section. For example, the area ratio of solid electrolyte in the cross-section can be determined by carrying out an elemental analysis of a cross-section of the composite particle 1 by EDX and identifying the region where solid electrolyte is present in the cross-section. In each of the cross-sections of the center portion 1a and the surface layer portion 1b, by determining the area ratios of the solid electrolyte, it is possible to specify whether or not the ratio of solid electrolyte 1ax in the center portion 1a is higher than the ratio of solid electrolyte in the surface layer portion 1b.

### 1.5 Porosity in Each of Center Portion and Surface Layer Portion

For the active material composite particle 1, when a cross-section of the composite particle 1 is observed, the porosity in the center portion 1a of the composite particle 1 may be higher than the porosity in the surface layer portion 1b of the composite particle 1. As such, since the porosity in the center portion 1a is higher than the porosity in the surface layer portion 1b, even when Si particles in the center portion 1a expand due to charging, the Si particles expand to fill the voids, the volume change of the composite particle 1 as a whole is moderated, and the shape of the composite particle 1 as a whole is easily maintained. In addition, since the volume change of the composite particle 1 as a whole is moderated, cracks and gaps in the material surrounding the composite particle 1 are less likely to occur. Thus, according to such an active material composite particle 1, more excellent cycle characteristics are easily exhibited.

The porosities in the center portion 1a and the surface layer portion 1b of the active material composite particle 1 can be determined by carrying out an elemental analysis of a cross-section of the composite particle 1 by EDX and identifying the region where the voids are present in the cross-section.

### 1.6 Materials Constituting Each of Center Portion and Surface Layer Portion

As described above, the center portion 1a of the active material composite particle 1 comprises a solid electrolyte 1ax and a plurality of Si particles 1ay, and the surface layer portion 1b of the active material composite particle 1 comprises a polymer 1bx. In addition, as described above, the center portion 1a may comprise a polymer. In this case, the polymer contained in the center portion 1a and the polymer contained in the surface layer portion 1b may be of the same type or different types. Further, the surface layer portion 1b may comprise one or both of a solid electrolyte and Si particles. In this case, the solid electrolyte contained in the center portion 1a and the solid electrolyte contained in the surface layer portion 1b may be of the same type or different types, and the Si particles contained in the center portion 1a and Si particles contained in the surface layer portion 1b may be of the same type or different types.

### 1.6.1 Solid Electrolyte

The center portion 1a of the active material composite particle 1 comprises a solid electrolyte 1ax. By containing a solid electrolyte 1ax in the center portion 1a, the carrier ion-conducting property of the center portion 1a is enhanced, whereby during charging and discharging, reaction nonuniformity of Si particles 1ay in the center portion 1a is easily suppressed, and cracking of Si particles 1ay associated with charging and discharging is easily suppressed. As a result, excellent cycle characteristics are easily exhibited.

The carrier ion conductivity of the solid electrolyte 1ax may be higher than the carrier ion conductivity of the surface layer portion 1b. By containing a solid electrolyte having excellent carrier ion-conductivity in the center portion 1a, reaction nonuniformity of Si particles 1ay in the center portion 1a during charging and discharging can be further suppressed, and cracking of Si particles 1ay associated with charging and discharging can be further suppressed. As a result, more excellent cycle characteristics are easily exhibited.

The solid electrolyte 1ax may be, for example, an inorganic solid electrolyte. Inorganic solid electrolytes have excellent heat resistance in addition to excellent carrier ion-conductivity. When lithium ions are adopted as the carrier ions, the inorganic solid electrolyte may be at least one selected from, for example, oxide solid electrolytes such as lithium lanthanum zirconate, LiPON, Li_{1+X}Al_{X}Ge_{2-X}(PO₄)₃, Li—SiO-based glass, and Li—Al—S—O-based glass; and sulfide solid electrolytes such as Li₂S—P₂S₅, Li₂S—SiS₂, LiI—Li₂S—SiS₂, LiI—Si₂S—P₂S₅, Li₂S—P₂S₅—LiI—LiBr, LiI—Li₂S—P₂S₅, LiI—Li₂S—P₂O₅, LiI—Li₃PO₄—P₂S₅, and Li₂S—P₂S₅—GeS₂. Particularly, when the solid electrolyte 1ax comprises a sulfide solid electrolyte, a higher performance is easily exhibited. Among sulfide solid electrolytes, those comprising at least Li, S, and P as constituent elements have a high performance. The solid electrolyte 1ax may be amorphous or crystalline.

The solid electrolyte 1ax may be, for example, particulate. One type of solid electrolyte 1ax may be used alone, or two or more types may be used in combination.

The solid electrolyte optionally contained in the surface layer portion 1b of the active material composite particle 1 is the same as that above. As will be described below, the surface layer portion 1b may comprise a salt, and the salt may comprise a carrier ion. Specifically, the surface layer portion 1b may comprise a salt having a carrier ion-conductivity. In the present application, the “salt” contained in the surface layer portion 1b is regarded as different from the above “solid electrolyte”.

### 1.6.2 Si Particles

The center portion 1a of the active material composite particle 1 comprises a plurality of Si particles 1ay. Each of the plurality of Si particles 1ay may exist as a primary particle or as a secondary particle. The composition of each of the Si particles 1ay is not particularly limited. The ratio of Si element to all elements contained in the Si particles 1ay may be, for example, 50 mol % or greater, 70 mol % or greater, or 90 mol % or greater. The Si particles 1ay, other than Si element, may comprise additional elements, for example, alkali metal elements such as Li element. Examples of the additional element other than Li element include Sn element, Fe element, Co element, Ni element, Ti element, Cr element, B element, and P element. Further, the Si particles 1ay may comprise impurities such as an oxide. The Si particles 1ay may be amorphous or crystalline. The crystal phase contained in the Si particles 1ay is not particularly limited.

The size of the Si particles 1ay is not particularly limited. The average primary particle diameter of the Si particles 1ay may be, for example, 10 nm or more, 30 nm or more, 50 nm or more, 100 nm or more, or 150 nm or more, and may be 10 μm or less, 5 μm or less, 3 μm or less, 2 μm or less, or 1 μm or less. The average secondary particle diameter of the Si particles may be, for example, 100 nm or more, 1 μm or more, or 2 μm or more, and may be 20 μm or less, 15 μm or less, or 10 μm or less. The average primary particle diameter and the average secondary particle diameter can be determined by observation with an electron microscope such as SEM, and can be determined, for example, as average values of maximum Feret diameters of a plurality of particles. The number of samples is preferably large, for example, 20 or more, and may be 50 or more or 100 or more. The average primary particle diameter and the average secondary particle diameter can be appropriately adjusted by, for example, appropriately changing the manufacturing conditions of the Si particles 1ay or by carrying out a classification treatment.

The Si particles 1ay may be porous. By making the Si particles 1ay porous, expansion of the Si particles 1ay during charging can be mitigated by voids in the particles. The state of voids in the porous Si particles is not particularly limited. The porous Si particles may be particles comprising nanoporous silicon. Nanoporous silicon refers to silicon in which a plurality of pores having a pore size in the order of nanometers (less than 1000 nm, preferably 100 nm or less) are present. The porous Si particles may comprise pores having a diameter of 55 nm or less. Pores having a diameter of 55 nm or less are not easily crushed even by pressing. In other words, porous Si particles comprising pores having a diameter of 55 nm or less easily maintain a porous quality even after pressing. For example, pores having a diameter of 55 nm or less per g of porous Si particles may be contained in 0.21 cc/g or more, 0.22 cc/g or more, or 0.23 cc/g or more, and may be contained in 0.30 cc/g or less, 0.28 cc/g or less, or 0.26 cc/g or less. The volume of pores having a diameter of 55 nm or less contained in the porous Si particles can be determined from a pore size distribution by, for example, a nitrogen gas adsorption method or DFT method.

When Si particles 1ay are porous, the porosity thereof is not particularly limited. The porosity of the porous Si particles may be, for example, 1% or greater, 5% or greater, 10% or greater, or 20% or greater, and may be 80% or less, 70% or less, 60% or less, 50% or less, 40% or less, or 30% or less. The porosity of the Si particles can be determined by, for example, observation with a scanning electron microscope (SEM). The number of samples is preferably large, for example, 100 or more. The porosity can be an average value determined from these samples.

The Si particles optionally contained in the surface layer portion 1b of the active material composite particle 1 may be the same as the Si particles described above.

The number of Si particles contained in one active material composite particle 1 is not particularly limited. The number may be 2 or greater, 5 or greater, 10 or greater, or 50 or greater, and may be 1000 or less, 500 or less, or 100 or less.

### 1.6.3 Polymer

The surface layer portion 1b of the active material composite particle 1 comprises a polymer 1bx. The polymer 1bx can function as, for example, a binder that binds Si particles together and maintains the shape of the composite particle 1. In addition, the polymer 1bx can function as a cushioning material. The type of the polymer 1bx is not particularly limited. The polymer 1bx may be adopted from various binders known as constituent materials for secondary batteries. For example, the polymer 1bx contained in the surface layer portion 1b may be at least one selected from butadiene rubber (BR)-based binders, butylene rubber (IIR)-based binders, acrylate-butadiene rubber (ABR)-based binders, styrene-butadiene rubber (SBR)-based binders, polyvinylidene fluoride (PVdF)-based binders, polytetrafluoroethylene (PTFE)-based binders, polyimide (PI)-based binders, carboxymethyl cellulose (CMC)-based binders, polyacrylate-based binders, and polyacrylic acid ester-based binders. Particularly, PVdF-based binders have a high performance. The PVdF-based binder may be a copolymer comprising units derived from monomers other than VdF. One type of polymer may be used alone, or two or more types may be used in combination.

The polymer optionally contained in the center portion 1a of the active material composite particle 1 may be the same as that above.

### 1.6.4 Additional Components Such as Salt

The active material composite particle 1 may consist of only the above solid electrolyte, Si particles, and a polymer (as well as voids), or may comprise additional components other than those. Examples of the additional component include various solid components and liquid components. For example, the surface layer portion 1b of the active material composite particle 1 may comprise a salt, and the salt may comprise a carrier ion. By including a carrier ion-containing salt in the surface layer portion 1b, carrier ion-conductivity of the surface layer portion 1b is improved and resistance of the surface layer portion 1b is easily decreased. The volume ratio VR₇ of carrier ion-containing salt in the surface layer portion 1b may be, for example, 0% by volume or greater or greater than 0% by volume, and may be 50% by volume or less or 10% by volume or less. The salt contained in the surface layer portion 1b may or may not be dissociated into cations and anions.

The carrier ion-containing salt is a salt comprising at least a carrier ion as a cation. The carrier ion type is selected according to the application (for example, when applied to a secondary battery, the carrier ion type of the secondary battery) of the active material composite particle 1, and may be, for example, a lithium ion, a sodium ion, a potassium ion, or a cesium ion. When the active material composite particle 1 is applied to a lithium-ion battery, the carrier ion-containing salt comprises at least a lithium ion as a cation. In addition, the carrier ion-containing salt may comprise a cation other than the carrier ion. For example, the carrier ion-containing salt may comprise at least one cation selected from an ammonium ion, a phosphonium ion, a pyridinium ion, and a pyrrolidinium ion.

The carrier ion-containing salt may include various anions. For example, the carrier ion-containing salt may include at least one anion selected from halogen ions, halide ions, hydrogen sulfate ions, sulfonylamide ions, and complex ions comprising H.

The halogen ion may be one or both of a bromine ion and a chlorine ion.

The sulfonylamide anion (also referred to as sulfonylimide anion) may be at least one selected from, for example, a trifluoromethanesulfonylamide anion (TFSA anion, (CF₃SO₂)₂N), a fluorosulfonylamide anion (FSA anion, (FSO₂)₂N⁻), and a fluorosulfonyl(trifluoromethanesulfonyl)amide anion (FTA anion, FSO₂(CF₃SO₂)N⁻). The sulfonylamide anion may be of one type only or a combination of two or more types. Of the above sulfonylamide anions, TFSA anion is weakly polar and has particularly low reactivity with other materials. In this regard, when the carrier ion-containing salt comprises a TFSA anion, reaction between the carrier ion-containing salt and other materials is more easily suppressed.

The complex ion comprising H may comprise, for example, an element M comprising at least one of a nonmetallic element and a metallic element; and H bonded to the element M. In the complex ion comprising H, the element M as the center element and each H surrounding the element M may be bonded to each other via covalent bonding. The complex ion comprising H may be represented by (MmHn)^{α-}. In this case, m is any positive number, n and a can take any positive number depending on m and the valence of the element M. The element M may be any nonmetallic element or metallic element capable of forming a complex ion. For example, the element M may include at least one of B, C, and N as a nonmetallic element, or may comprise B. For example, the element M may include at least one of Al, Ni, and Fe as a metallic element. Particularly when the complex ion comprises B or comprises C and B, higher ion-conducting property is easily ensured. Specific examples of the complex ion comprising H include (CB₉H₁₀)⁻, (CB₁₁H₁₂)⁻, (B₁₀H₁₀)²⁻, (B₁₂H₁₂)²⁻, (BH₄)⁻, (NH₂)⁻, (AlH₄)⁻, and combinations thereof. Particularly, when (CB₉H₁₀)⁻, (CB₁₁H₁₂)⁻, or a combination thereof is used, higher ion-conducting property is easily ensured.

### 1.7 Particle Size of Active Material Composite Particle

The active material composite particle 1 can be regarded as a secondary particle comprising a solid electrolyte, a plurality of Si particles, and a polymer. The average particle size of the composite particles 1 is not particularly limited. The average particle diameter of the composite particles 1 may be 100 nm or more, 1 μm or more, 2 μm or more, or 3 μm or more, and may be 20 μm or less, 15 μm or less, or 10 μm or less. The average particle diameter of the composite particles 1 can be determined by observation with an electron microscope such as SEM, and can be determined as, for example, an average value of maximum Feret diameters of a plurality of composite particles. The number of samples is preferably large, for example, 20 or more, and may be 50 or more or 100 or more. Alternatively, the average particle diameter (D50, median diameter) of the composite particles 1 extracted only from the composite particles 1 and measured using a laser diffraction particle distribution analyzer may be 100 nm or more, 1 μm or more, 2 μm or more, or 3 μm or more, and may be 20 μm or less, 15 μm or less, or 10 μm or less.

### 1.8 Structure and Shape of Active Material Composite Particle

As described above, the active material composite particle 1 comprises a center portion 1a comprising a solid electrolyte 1ax and a plurality of Si particles 1ay and a surface layer portion 1b comprising a polymer 1bx, and may have a core-shell structure with a center portion 1a and a surface layer portion 1b. As described above, when a cross-section of the active material composite particle 1 is observed, if a boundary is observed between the polymer-rich outermost layer and a layer at an inner portion thereof, the outermost layer on the outside of the boundary is regarded as the surface layer portion 1b, and the inside (inner portion) of the boundary as the center portion 1a. In this case, the surface layer portion 1b may have a thickness of, for example, 10 nm or more and 0.5 μm or less. The active material composite particle 1, for example, may have a long diameter and a short diameter in a state prior to being used in a secondary battery. The ratio (long diameter/short diameter) of long diameter to short diameter may be, for example, 1.0 or greater or 1.1 or greater, and may be 1.3 or less or 1.2 or less. As described below, when the active material composite particle 1 is used in a negative electrode active material layer of a secondary battery, the negative electrode active material layer can be formed by pressing a negative electrode active material mixture comprising the active material composite particles 1. At this time, the composite particles 1 can be crushed in the pressing direction and have a predetermined aspect ratio or higher. By pressing the composite particles 1 to obtain a predetermined aspect ratio or higher, contact resistance between composite particles and contact resistance between the composite particles and other materials are easily decreased. Specifically, from the viewpoint of further decreasing resistance in the negative electrode described below, when a cross-section of the negative electrode active material layer is observed, half or more (50% or greater in number ratio) of the plurality of composite particles 1 extracted by the following extraction method may have an aspect ratio of 1.5 or higher.

Extraction method: A cross-section of the active material layer is observed; composite particles contained in the cross-section are extracted in descending order of cross-sectional area; and the extraction is ended when the total area of the extracted composite particles exceeds 80% of the total area of all composite particles contained in the cross-section.

The above extraction method may be carried out by image analysis based on a cross-sectional image of the active material layer acquired by SEM. In the image analysis, the aspect ratio of each composite particle may be specified after an elliptical approximation of the composite particles included in the image.

### 1.9 Carrier Ion-Conductivity of Active Material Composite Particle

As described above, the center portion 1a of the active material composite particle 1 comprises a solid electrolyte 1ax and thereby has excellent carrier ion-conductivity. The surface layer portion 1b comprises a polymer 1bx and has a carrier ion-conductivity. In the surface layer portion 1b, the polymer 1bx itself may have a carrier ion-conductivity, or the polymer 1bx and the carrier ion-containing salt may be combined to exhibit a carrier ion-conductivity as described above. For example, a PVdF-based binder as a polymer itself has a carrier ion-conductivity, and by combining a carrier ion-containing salt with the PVdF-based binder, further excellent carrier ion-conductivity can be ensured. The carrier ion conductivity of the surface layer portion 1b may be specified by actual measurement using a material having the same composition as that of the surface layer portion 1b, or may be specified by calculation from the composition of the surface layer portion 1b.

### 2. Electrode

The technique of the present disclosure also includes an aspect as an electrode. Specifically, the electrode of the present disclosure comprises the active material composite particle 1 of the present disclosure. The electrode of the present disclosure may comprise, for example, the active material composite particle 1 and a solid electrolyte disposed around the active material composite particle 1. Specific examples of the solid electrolyte are as described above. In the electrode, the solid electrolyte contained in the active material composite particle 1 and the solid electrolyte disposed around the active material composite particle 1 may be of the same type or different types. The case where the electrode of the present disclosure is applied to a negative electrode of a secondary battery will be exemplified below.

### 3. Secondary Battery

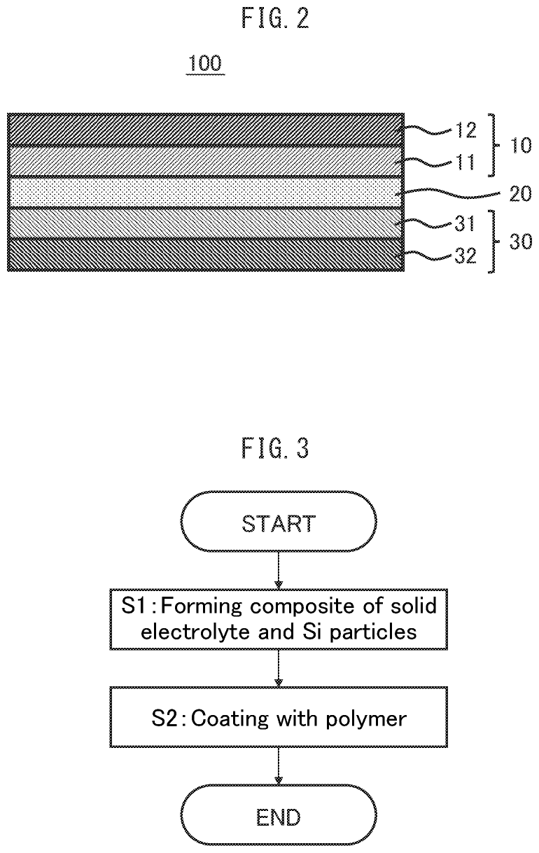

FIG. 2 schematically shows a configuration of a secondary battery 100 according to one embodiment. As shown in FIG. 2, the secondary battery 100 comprises a positive electrode 10, an electrolyte layer 20, and a negative electrode 30. The negative electrode 30 comprises the above active material composite particle 1. In the secondary battery 100, the negative electrode 30 may comprise active material composite particles 1 and a solid electrolyte disposed around the active material composite particles 1. In the secondary battery 100, the electrolyte layer 20 may comprise a solid electrolyte. In the secondary battery 100, the positive electrode 10 may comprise a solid electrolyte. In the secondary battery 100, the positive electrode 10, the electrolyte layer 20, and the negative electrode 30 may all comprise a solid electrolyte. Further, the secondary battery 100 may be a solid-state battery. A solid-state battery refers to a battery in which an electrolyte having a carrier ion-conductivity is mainly composed of a solid electrolyte. However, a liquid component at an additive level may be contained. Alternatively, the secondary battery 100 may be an all-solid-state battery substantially free of a liquid component.

### 3.1 Positive Electrode

The configuration of the positive electrode 10 is not particularly limited as long as the positive electrode can appropriately function as a positive electrode for secondary batteries. As shown in FIG. 2, the positive electrode 10 may comprise a positive electrode active material layer 11 and a positive electrode current collector 12.

### 3.1.1 Positive Electrode Active Material Layer

The positive electrode active material layer 11 comprises at least a positive electrode active material, and may further optionally comprise an electrolyte, a conductive aid, and a binder. The positive electrode active material layer 11 may additionally comprise various additives. The content of each component in the positive electrode active material layer 11 may be appropriately determined according to the target battery performance. For example, when the entire positive electrode active material layer 11 (total solid content) is set to 100% by mass, the content of the positive electrode active material may be 40% by mass or greater, 50% by mass or greater, 60% by mass or greater, or 70% by mass or greater, and may be 100% by mass or less or 90% by mass or less. The shape of the positive electrode active material layer 11 is not particularly limited, and may be, for example, a sheet-like positive electrode active material layer having a substantially flat surface. The thickness of the positive electrode active material layer 11 is not particularly limited, and may be, for example, 0.1 μm or more, 1 μm or more, or 10 μm or more, and may be 2 mm or less, 1 mm or less, or 500 μm or less.

Any known positive electrode active material for secondary batteries may be used as the positive electrode active material. Of the known active materials, a material having a relatively higher potential (charge-discharge potential) at which a predetermined carrier ion (for example, lithium ion) is stored and released can be used as the positive electrode active material. The positive electrode active material may be, for example, at least one selected from various lithium-containing compounds, elemental sulfur, and sulfur compounds. The lithium-containing compound as the positive electrode active material may be any of various lithium-containing oxides such as lithium cobaltate, lithium nickel oxide, Li_{1±α}Ni_{1/3}Co_{1/3}Mn_{1/3}O_{2±δ}, lithium manganate, spinel-based lithium compounds (such as heterogeneous element-substituted Li—Mn spinel having a composition represented by Li_{1+X}Mn_{2-x-y}M_{y}O₄, wherein M is one or more selected from Al, Mg, Co, Fe, Ni, and Zn), lithium titanate, and lithium metal phosphate (such as LiMPO₄, wherein M is one or more selected from Fe, Mn, Co, and Ni). Particularly, when the positive electrode active material comprises a lithium-containing oxide comprising at least Li; at least one of Ni, Co, and Mn; and O as constituent elements, a greater effect can be expected. One type of positive electrode active material may be used alone, or two or more types may be used in combination.

Any general shape for a positive electrode active material for batteries may be used as the shape of the positive electrode active material. The positive electrode active material may be, for example, particulate. The positive electrode active material may be solid or hollow, may have voids, or may be porous. The positive electrode active material may be primary particles, or may be secondary particles of a plurality of agglomerated primary particles. The average particle diameter D50 of the positive electrode active material may be, for example, 1 nm or more, 5 nm or more, or 10 nm or more, and may be 500 μm or less, 100 μm or less, 50 μm or less, or 30 μm or less. The average particle diameter D50 as described herein is a particle diameter (median diameter) at an integrated value of 50% in a volume-based particle size distribution determined by a laser diffraction or scattering method.

A protective layer containing an ion-conducting oxide may be formed on the surface of the positive electrode active material. As a result, a reaction between the positive electrode active material and a sulfide (for example, a sulfide solid electrolyte described below) can be easily suppressed. Examples of the ion-conducting oxide include Li₃BO₃, LiBO₂, Li₂CO₃, LiAlO₂, Li₄SiO₄, Li₂SiO₃, Li₃PO₄, Li₂SO₄, Li₂TiO₃, Li₄Ti₅O₁₂, Li₂Ti₂O₅, Li₂ZrO₃, LiNbO₃, Li₂MoO₄, and Li₂WO₄. The ion-conducting oxide may be partially substituted with a doping element such as P or B. The coverage (area ratio) of the protective layer on the surface of the positive electrode active material may be, for example, 70% or greater, 80% or greater, or 90% or greater. The thickness of the protective layer may be, for example, 0.1 nm or more or 1 nm or more, and may be 100 nm or less or 20 nm or less.

The electrolyte that may be contained in the positive electrode active material layer 11 may be a solid electrolyte, a liquid electrolyte (electrolytic solution), or a combination thereof. Particularly, when the positive electrode active material layer 11 comprises at least a solid electrolyte as the electrolyte, a greater effect is easily obtained.

Any solid electrolyte known as a solid electrolyte for secondary batteries may be used. The solid electrolyte may be an inorganic solid electrolyte or an organic polymer electrolyte. Particularly, the inorganic solid electrolyte has high ion conductivity and excellent heat resistance. Examples of the inorganic solid electrolyte can include oxide solid electrolytes such as lithium lanthanum zirconate, LiPON, Li_{1+X}Al_{X}Ge_{2-X}(PO₄)₃, Li—SiO-based glass, and Li—Al—S—O-based glass; and sulfide solid electrolytes such as Li₂S—P₂S₅, Li₂S—SiS₂, LiI—Li₂S—SiS₂, LiI—Si₂S—P₂S₅, Li₂S—P₂S₅—LiI—LiBr, LiI—Li₂S—P₂S₅, LiI—Li₂S—P₂O₅, LiI—Li₃PO₄—P₂S₅, and Li₂S—P₂S₅—GeS₂. Particularly, among sulfide solid electrolytes, sulfide solid electrolytes comprising at least Li, S, and P as constituent elements have a high performance. The solid electrolyte may be amorphous or crystalline. The solid electrolyte may be, for example, particulate. One type of solid electrolyte may be used alone, or two or more types may be used in combination.

The electrolytic solution can comprise a predetermined carrier ion (for example, lithium ion). The electrolytic solution may be, for example, a nonaqueous electrolytic solution. The composition of the electrolytic solution may be the same as one known as a composition of an electrolytic solution for secondary batteries. For example, an electrolytic solution in which a predetermined concentration of a lithium salt dissolved in a carbonate-based solvent can be used. Examples of the carbonate-based solvent include fluoroethylene carbonate (FEC), ethylene carbonate (EC), and dimethyl carbonate (DMC). Examples of the lithium salt include LiPF₆.

Examples of the conductive aid that may be contained in the positive electrode active material layer 11 include carbon materials such as vapor-grown carbon fiber (VGCF), acetylene black (AB), Ketjen black (KB), carbon nanotube (CNT), and carbon nanofiber (CNF); and metal materials such as nickel, aluminum, and stainless steel. The conductive aid may be, for example, particulate or fibrous, and the size thereof is not particularly limited. One type of conductive aid may be used alone, or two or more types may be used in combination.

Examples of the binder that may be contained in the positive electrode active material layer 11 include butadiene rubber (BR)-based binders, butylene rubber (IIR)-based binders, acrylate-butadiene rubber (ABR)-based binders, styrene-butadiene (SBR)-based binders, polyvinylidene fluoride (PVdF)-based binders, polytetrafluoroethylene (PTFE)-based binders, and polyimide (PI)-based binders. One type of binder may be used alone, or two or more types may be used in combination.

### 3.1.2 Positive Electrode Current Collector

As shown in FIG. 2, the positive electrode 10 may comprise a positive electrode current collector 12 in contact with the above positive electrode active material layer 11. Any general positive electrode current collector for batteries can be adopted as the positive electrode current collector 12. The positive electrode current collector 12 may be a foil, a plate, a mesh, a punched metal, or a foam. The positive electrode current collector 12 may be composed of a metal foil or a metal mesh. Particularly, a metal foil has excellent handleability. The positive electrode current collector 12 may be formed of a plurality of foils. Examples of the metal constituting the positive electrode current collector 12 include Cu, Ni, Cr, Au, Pt, Ag, Al, Fe, Ti, Zn, Co, and stainless steel. Particularly, from the viewpoint of ensuring oxidation resistance, the positive electrode current collector 12 may comprise Al. The positive electrode current collector 12 may have on the surface thereof some coating layer for the purpose of adjusting resistance. The positive electrode current collector 12 may be a metal foil or a substrate plated or vapor-deposited with the above metal. When the positive electrode current collector 12 is composed of a plurality of metal foils, there may be some layer between the plurality of metal foils. The thickness of the positive electrode current collector 12 is not particularly limited, and may be, for example, 0.1 μm or more or 1 μm or more, and may be 1 mm or less or 100 μm or less.

### 3.2 Electrolyte Layer

The electrolyte layer 20 is disposed between the positive electrode 10 and the negative electrode 30 and can function as a separator. The electrolyte layer 20 comprises at least an electrolyte, and may further optionally comprise a binder. The electrolyte layer 20 may further comprise various additives. The content of each component in the electrolyte layer 20 is not particularly limited, and may be appropriately determined according to the target battery performance. The shape of the electrolyte layer 20 is not particularly limited, and may be, for example, a sheet having a substantially flat surface. The thickness of the electrolyte layer 20 is not particularly limited, and may be, for example, 0.1 μm or more or 1 μm or more, and may be 2 mm or less or 1 mm or less.

### 3.2.1 Electrolyte

The electrolyte contained in the electrolyte layer 20 may be appropriately selected from those exemplified as electrolytes that may be contained in the positive electrode active material layer described above. Particularly, an electrolyte layer 20 comprising a solid electrolyte, especially a sulfide solid electrolyte, and especially a sulfide solid electrolyte comprising at least Li, S, and P as constituent elements, has a high performance. When the electrolyte is a solid electrolyte, the solid electrolyte may be amorphous or crystalline. When the electrolyte is a solid electrolyte, the solid electrolyte may be, for example, particulate. One type of electrolyte may be used alone, or two or more types may be used in combination. Further, the electrolyte contained in the electrolyte layer 20 and the electrolyte contained in the positive electrode active material layer 11 may be of the same type or different types.

### 3.2.2 Binder

The binder that may be contained in the electrolyte layer 20 may be, for example, appropriately selected from those exemplified as binders that may be contained in the positive electrode active material layer described above. The binder contained in the electrolyte layer 20 and the binder contained in the positive electrode active material layer 11 may be of the same type or different types.

### 3.3 Negative Electrode

The negative electrode 30 comprises the above active material composite particle 1, and the configuration thereof is not particularly limited as long as the negative electrode can appropriately function as a negative electrode for secondary batteries. As shown in FIG. 2, the negative electrode 30 may comprise a negative electrode active material layer 31 and a negative electrode current collector 32.

### 3.3.1 Negative Electrode Active Material Layer

The negative electrode active material layer 31 comprises at least active material composite particles 1, and may further optionally comprise an additional active material, an electrolyte, a conductive aid, and a binder. The negative electrode active material layer 31 may additionally comprise various additives. The content of each component in the negative electrode active material layer 31 may be appropriately determined according to the target battery performance. For example, when the entire negative electrode active material layer 31 (total solid content) is set to 100% by mass, the content of the active material composite particles 1 may be 40% by mass or greater, 50% by mass or greater, 60% by mass or greater, or 70% by mass or greater, and may be 100% by mass or less or 90% by mass or less. The shape of the negative electrode active material layer 31 is not particularly limited, and may be, for example, a sheet-like negative electrode active material layer having a substantially flat surface. The thickness of the negative electrode active material layer 31 is not particularly limited, and may be, for example, 0.1 μm or more, 1 μm or more, or 10 μm or more, and may be 2 mm or less, 1 mm or less, or 500 μm or less.

The active material composite particle 1 is as described above. The active material composite particle 1 may be contained in a pressed state in the negative electrode active material layer 31. Specifically, when the active material composite particle 1 is used in the negative electrode active material layer 31 of a secondary battery 100, the negative electrode active material layer 31 can be formed by pressing a negative electrode active material mixture comprising the active material composite particles 1. At this time, the composite particles 1 can be crushed in the pressing direction and have a predetermined aspect ratio or higher. By pressing the composite particles 1 to obtain a predetermined aspect ratio or higher, contact resistance within the composite particle 1, contact resistance between composite particles 1, and contact resistance between the composite particles 1 and other materials are easily decreased. One example of the aspect ratio of the composite particle 1 in this case is as described above.

Any known negative electrode active material for secondary batteries may be used as the negative electrode active material in addition to the active material composite particle 1. Of the known active materials, a material having a relatively lower potential (charge-discharge potential) at which a predetermined carrier ion (for example, lithium ion) is stored and released can be used as the negative electrode active material. One type of the additional negative electrode active material may be used alone, or two or more types may be used in combination. From the viewpoint of further enhancing performance of a secondary battery, the higher the ratio of active material composite particles 1 in the entire negative electrode active material contained in the negative electrode active material layer 31, the better. For example, when the total of the active material composite particles 1 and the additional negative electrode active material is set to 100% by mass, 50% by mass or greater, 60% by mass or greater, 70% by mass or greater, 80% by mass or greater, 90% by mass or greater, or 95% by mass or greater of the active material composite particles 1 may be contained. The upper limit thereof is 100% by mass.

The electrolyte that may be contained in the negative electrode active material layer 31 may be a solid electrolyte, a liquid electrolyte (electrolytic solution), or a combination thereof. Particularly, when the negative electrode active material layer 31 comprises at least a solid electrolyte, a greater effect is easily obtained. Specifically, the negative electrode 30 can comprise the active material composite particles 1 and a solid electrolyte disposed therearound. The negative electrode active material layer 31 may comprise a solid electrolyte, especially a sulfide solid electrolyte, and especially a sulfide solid electrolyte comprising Li, S, and P as constituent elements. The electrolyte contained in the negative electrode active material layer 31 and the electrolyte contained in the positive electrode active material layer 11 and the electrolyte layer 20 may be of the same type or different types. Examples of the conductive aid that may be contained in the negative electrode active material layer 31 include the carbon materials described above and the metal materials described above. The conductive aid contained in the negative electrode active material layer 31 and the conductive aid contained in the positive electrode active material layer 11 may be of the same type or different types. The binder that may be contained in the negative electrode active material layer 31 may be appropriately selected from, for example, those exemplified as binders that may be contained in the positive electrode active material layer 11 described above. The binder contained in the negative electrode active material layer 31 and the binder contained in the positive electrode active material layer 11 and the electrolyte layer 20 may be of the same type or different types.

### 3.3.2 Negative Electrode Current Collector

As shown in FIG. 2, the negative electrode 30 may comprise a negative electrode current collector 32 in contact with the above negative electrode active material layer 31. Any general negative electrode current collector for batteries can be adopted as the negative electrode current collector 32. The negative electrode current collector 32 may be a foil, a plate, a mesh, a punched metal, or a foam. The negative electrode current collector 32 may be a metal foil or a metal mesh, or may be a carbon sheet. Particularly, a metal foil has excellent handleability. The negative electrode current collector 32 may be formed of a plurality of foils or sheets. Examples of the metal constituting the negative electrode current collector 32 include Cu, Ni, Cr, Au, Pt, Ag, Al, Fe, Ti, Zn, Co, and stainless steel. Particularly, from the viewpoints of ensuring reduction resistance and making alloying with lithium difficult, the negative electrode current collector 32 may comprise at least one metal selected from Cu, Ni, and stainless steel. The negative electrode current collector 32 may have on the surface thereof some coating layer for the purpose of adjusting resistance. The negative electrode current collector 32 may be a metal foil or a substrate plated or vapor-deposited with the above metal. When the negative electrode current collector 32 is made of a plurality of metal foils, there may be some layer between the plurality of metal foils. The thickness of the negative electrode current collector 32 is not particularly limited, and may be, for example, 0.1 μm or more or 1 μm or more, and may be 1 mm or less or 100 μm or less.

### 3.4 Additional Configurations

In the secondary battery 100, each of the above components may be housed inside an outer packaging. Any known outer packaging for batteries can be adopted as the outer packaging. In addition, a plurality of batteries 100 may be optionally electrically connected and optionally stacked to form a battery pack. In this case, the battery pack may be housed inside a known battery case. The secondary battery 100 may comprise obvious components such as the necessary terminals. Examples of the shape of the secondary battery 100 can include a coin, a laminate, a cylinder, and a rectangle.

### 4. Manufacturing Method for Secondary Battery

The secondary battery 100 can be manufactured by applying a known method. For example, the secondary battery 100 can be manufactured by the following method. However, the manufacturing method for the secondary battery 100 is not limited to the following method, and each layer may be formed by, for example, dry molding.
(1) Active material composite particles and etc. constituting a negative electrode active material layer are dispersed in a solvent to obtain a negative electrode slurry. The solvent used in this case is not particularly limited. Water and various organic solvents can be used. The negative electrode slurry is then applied to a surface of a negative electrode current collector or an electrolyte layer described below using a doctor blade, followed by drying, to form a negative electrode active material layer on the surface of the negative electrode current collector or the electrolyte layer to obtain a negative electrode. The negative electrode active material layer may be compression-molded.
(2) A positive electrode active material and etc. constituting a positive electrode active material layer is dispersed in a solvent to obtain a positive electrode slurry. The solvent used in this case is not particularly limited. Water and various organic solvents can be used. The positive electrode slurry is then applied to a surface of a positive electrode current collector or an electrolyte layer described below using a doctor blade, followed by drying, to form a positive electrode active material layer on the surface of the positive electrode current collector or the electrolyte layer to obtain a positive electrode. The positive electrode active material layer may be compression-molded.
(3) The layers are laminated such that an electrolyte layer is interposed between the negative electrode and the positive electrode, in the order of negative electrode current collector, negative electrode active material layer, electrolyte layer, positive electrode active material layer, and positive electrode current collector, to obtain a laminated body. The electrolyte layer, for example may be obtained by molding an electrolytic mixture comprising an electrolyte and a binder, or may be obtained by compression molding. The laminated body may be further compression-molded. Additional members such as terminals are attached to the laminated body as needed. When an electrolytic solution is used, a separator may be adopted in the electrolyte layer.
(4) The laminated body is housed in a battery case and sealed to obtain a secondary battery.

### 5. Manufacturing Method for Active Material Composite Particle

The above active material composite particle of the present disclosure can be manufactured, for example, according to the flow as shown in FIG. 3. Specifically, as shown in FIG. 3, the manufacturing method for the active material composite particle of the present disclosure comprises: mixing a solid electrolyte and a plurality of Si particles to obtain an intermediate composite particle (step S1); and coating the periphery of the intermediate composite particle with a material comprising a polymer and having a carrier ion-conductivity (step S2).

### 5.1 Step S1

In step S1, a solid electrolyte and a plurality of Si particles are mixed to obtain an intermediate composite particle. When mixing the solid electrolyte and the plurality of Si particles, a polymer may be used, and a composite of the solid electrolyte and the plurality of Si particles is thereby more easily formed. The mixing of the solid electrolyte and the plurality of Si particles may be a dry mixing of powders or a wet mixing using a solvent. The mixing means is not particularly limited. The mixing may be carried out manually using a mortar, or mechanically by various mixing devices. The intermediate composite particle obtained via the step S1 can constitute the above center portion 1a of the active material composite particle 1. The form and composition (ratio (volume ratio) of each component) of the intermediate composite particle may be the same as those described for the center portion 1a.

### 5.2 Step S2

In step S2, the periphery (surface) of the intermediate composite particle is coated with a material comprising a polymer and having a carrier ion-conductivity. Specifically, a material such as a polymer constituting the surface layer portion 1b is disposed around the intermediate composite particle constituting the center portion 1a. As a result, an active material composite 1 comprising a center portion 1a and a surface layer portion 1b is obtained. In the step S2, when the polymer itself has a carrier ion-conductivity, the material may consist of only the polymer. Alternatively, as described above, the material may be a combination of the polymer and a carrier ion-containing salt. In the step S2, the means of coating the periphery of the intermediate composite particle with the material is not particularly limited. For example, the periphery of the intermediate composite particle may be coated with the material by adhering the material to the surface of the intermediate composite particle by dry mixing of powders. In this case, the mixing means is not particularly limited. The mixing may be carried manually using a mortar, or mechanically by various mixing devices. Alternatively, the periphery of the intermediate composite particle may be coated with the material by dissolving the material in a solvent to prepare a solution, bringing the solution into contact with the surface of the intermediate composite particle, followed by drying. In this case, the solvent is not particularly limited. Neither is the means of bringing the solution into contact with the surface of the intermediate composite particle particularly limited. The active material composite particle 1 obtained via the step S2 comprises a center portion 1a composed of the above intermediate composite particle and a surface layer portion 1b composed of the above polymer and etc. The form and composition (ratio (volume ratio) of each component) of the surface layer portion 1b is as described above.

### 6. Method of Charging and Discharging Secondary Battery and Method of Improving Cycle Characteristics of Secondary Battery

When the active material composite particle of the present disclosure is contained in a negative electrode of a secondary battery, the cycle characteristics of the secondary battery is easily improved. Specifically, the method of charging and discharging a secondary battery and the method of improving cycle characteristics of a secondary battery in the present disclosure are characterized by comprising repeated charging and discharging of a secondary battery, wherein the secondary battery comprises a positive electrode, an electrolyte, and a negative electrode; and the negative electrode comprises the active material composite particle of the present disclosure.

### 7. Vehicle Having Secondary Battery

As described above, when the active material composite particle of the present disclosure is contained in a negative electrode of a secondary battery, an improvement in cycle characteristics of the secondary battery can be expected. A secondary battery having such excellent charging and discharging cycle characteristics can be suitably used in, for example, at least one type of vehicles selected from hybrid vehicle (HEV), plug-in hybrid vehicle (PHEV), and battery electric vehicle (BEV). Specifically, the technique of the present disclosure also includes an aspect of a vehicle having a secondary battery, wherein the secondary battery comprises a positive electrode, an electrolyte, and a negative electrode, and the negative electrode comprises the active material composite particle of the present disclosure.

### EXAMPLES

Hereinafter, the technique of the present disclosure will be further described in detail with reference to the Examples. However, the technique of the present disclosure is not limited to the following Examples.

### 1. Example 1

### 1.1 Production of Intermediate Composite Particle

A butyl butyrate solution containing a PVdF-based binder at a ratio of 5% by mass and a sulfide solid electrolyte material (Li₂S—P₂S₅-based glass ceramic) having an average particle diameter D50 of 0.1 μm were weighed so that the PVdF-based binder in the solution and the sulfide solid electrolyte material had a predetermined volume ratio and placed in a polypropylene (PP) container, butyl butyrate was further added thereto, and the mixture was stirred for 30 s with an ultrasonic dispersion apparatus (UH-50 manufactured by SMT). The stirred mixture was then shaken for 3 min with a shaker (TTM-1 manufactured by Sibata Scientific Technology Ltd.). A polymer electrolytic solution A1 was thereby obtained. The resulting polymer electrolytic solution A1 and Si particles (average particle diameter D50: 0.5 μm) were weighed so that the sulfide solid electrolyte material, PVdF-based binder, and Si particles had a volume ratio of 7.09:1.67:91.2, kneaded with an ultrasonic dispersion apparatus (UH-50 manufactured by SMT), then cast on a petri dish, and dried. An intermediate composite particle C1 comprising a sulfide solid electrolyte, a plurality of Si particles, and a PVdF-based binder was thereby obtained.

### 1.2 Production of Coating Solution

A butyl butyrate solution containing a PVdF-based binder at a ratio of 5% by mass and LiTFSI (lithium bis(trifluoromethanesulfonyl)imide, also referred to as LiTFSA) were weighed so that the PVdF-based binder in the solution and LiTFSI had a volume ratio of 2.81:1 and placed in a polypropylene (PP) container, butyl butyrate was further added thereto, and the mixture was stirred for 30 s with an ultrasonic dispersion apparatus (UH-50 manufactured by SMT). The stirred mixture was then shaken for 3 min with a shaker (TTM-1 manufactured by Sibata Scientific Technology Ltd.). A polymer electrolyte solution B1 for coating was thereby obtained.

### 1.3 Production of Active Material Composite Particle

The intermediate composite particle C1 and the polymer electrolytic solution B1 were weighed so that the sulfide solid electrolyte, PVdF-based binder, LiTFSI, and Si particles had a volume ratio of 6.87:3.95:0.84:88.3, kneaded with an ultrasonic dispersion apparatus (UH-50 manufactured by SMT), then cast on a petri dish, and dried. An active material composite particle according to Example 1 was thereby obtained. The active material composite particle according to Example 1 comprised a center portion and a surface layer portion, wherein the center portion comprised a sulfide solid electrolyte and a plurality of Si particles, the surface layer portion comprised a PVdF-based binder and has a carrier ion-conductivity, and the ratio of PVdF-based binder in the surface layer portion is higher than the ratio of PVdF-based binder in the center portion.

### 2. Example 2

### 2.1 Production of Intermediate Composite Particle

A butyl butyrate solution containing a PVdF-based binder at a ratio of 5% by mass and a sulfide solid electrolyte material (Li₂S—P₂S₅-based glass ceramic) having an average particle diameter D50 of 0.1 μm were weighed so that the PVdF-based binder in the solution and sulfide solid electrolyte material had a predetermined volume ratio and placed in a polypropylene (PP) container, butyl butyrate was further added thereto, and the mixture was stirred for 30 s with an ultrasonic dispersion apparatus (UH-50 manufactured by SMT). The stirred mixture was then shaken for 3 min with a shaker (TTM-1 manufactured by Sibata Scientific Technology Ltd.). A polymer electrolytic solution A2 was thereby obtained. The resulting polymer electrolytic solution A2 and Si particles (average particle diameter D50: 0.5 μm) were weighed so that the sulfide solid electrolyte material, PVdF-based binder, and Si particles had a volume ratio of 5.11:2.80:92.07, kneaded with an ultrasonic dispersion apparatus (UH-50 manufactured by SMT), then cast on a petri dish, and dried. An intermediate composite particle C2 comprising a sulfide solid electrolyte, a plurality of Si particles, and a PVdF-based binder was thereby obtained.

### 2.2 Production of Coating Solution

A butyl butyrate solution containing a PVdF-based binder at a ratio of 5% by mass and LiTFSI (lithium bis(trifluoromethanesulfonyl)imide) were weighed so that the PVdF-based binder in the solution and LiTFSI had a volume ratio of 1.52:1 and placed in a polypropylene (PP) container, butyl butyrate was further added thereto, and the mixture was stirred for 30 s with an ultrasonic dispersion apparatus (UH-50 manufactured by SMT). The stirred mixture was then shaken for 3 min with a shaker (TTM-1 manufactured by Sibata Scientific Technology Ltd.). A polymer electrolyte solution B₂ for coating was thereby obtained.

### 2.3 Production of Active Material Composite Particle

The intermediate composite particle C2 and the polymer electrolytic solution B₂ were weighed so that the sulfide solid electrolyte, PVdF-based binder, LiTFSI, and Si particles had a volume ratio of 5.01:4.03:0.84:90.12, kneaded with an ultrasonic dispersion apparatus (UH-50 manufactured by SMT), then cast on a petri dish, and dried. An active material composite particle according to Example 2 was thereby obtained. The active material composite particle according to Example 2 comprised a center portion and a surface layer portion, wherein the center portion comprised a sulfide solid electrolyte and a plurality of Si particles, the surface layer portion comprised a PVdF-based binder and has a carrier ion-conductivity, and the ratio of PVdF-based binder in the surface layer portion is higher than the ratio of PVdF-based binder in the center portion

### 3. Production of Negative Electrode

### 3.1 Comparative Example

Vapor grown carbon fibers (VGCF), a BR-based binder, and mesitylene were mixed with a homogenizer, a sulfide solid electrolyte material was then added and mixed with a homogenizer, and Si particles were finally added and stirred with a homogenizer to prepare a negative electrode slurry. The mass ratio of Si particles to sulfide solid electrolyte material to VGCF to BR-based binder was 100:77.6:5:8. The negative electrode slurry was applied onto a copper foil as a negative electrode current collector foil by a blade method, followed by drying on a hot plate at 100° C. for 30 min, to obtain a negative electrode according to Comparative Example.

### 3.2 Example 1

The active material composite particles according to Example 1 was used in place of Si particles. Specifically, VGCF, a BR-based binder, and mesitylene were mixed with a homogenizer, a sulfide solid electrolyte material was then added and mixed with a homogenizer, and the active material composite particles according to Example 1 were finally added and stirred with a homogenizer to prepare a negative electrode slurry. The mass ratio of Si particles to sulfide solid electrolyte material (including that in the composite particles) to VGCF to PVdF-based binder to LiTFSI to BR-based binder was 100:77.6:4.6:6.4:0.6:1.5. The negative electrode slurry was applied onto a Cu foil by the same method as in Comparative Example and dried to obtain a negative electrode according to Example 1.

### 3.3 Example 2

The active material composite particles according to Example 2 was used in place of Si particles. Specifically, VGCF, a BR-based binder, and mesitylene were mixed with a homogenizer, a sulfide solid electrolyte material was then added and mixed with a homogenizer, and the active material composite particles according to Example 2 were finally added and stirred with a homogenizer to prepare a negative electrode slurry. The mass ratio of Si particles to sulfide solid electrolyte material (including that in the composite particles) to VGCF to PVdF-based binder to LiTFSI to BR-based binder was 100:77.6:4.6:6.4:0.6:1.5. The negative electrode slurry was applied onto a Cu foil by the same method as in Comparative Example and dried to obtain a negative electrode according to Example 2.

### 4. Production of Positive Electrode

A positive electrode slurry was prepared by stirring an NCA-based positive electrode active material, a sulfide solid electrolyte material, VGCF, a PVdF-based binder, and butyl butyrate with an ultrasonic dispersion apparatus. The mass ratio of NCA-based positive electrode material to sulfide solid electrolyte material to VGCF to PVdF-based binder was 100:16:2:0.75. The positive electrode slurry was applied onto an A1 foil as a positive electrode current collector foil by a blade method, followed by drying on a hot plate at 100° C. for 30 min, to obtain a positive electrode.

### 5. Production of Solid Electrolyte Layer

A solid electrolyte layer slurry was prepared by stirring a sulfide solid electrolyte material, a PVdF-based binder, and butyl butyrate with an ultrasonic dispersion apparatus. The mass ratio of sulfide solid electrolyte material to PVdF-based binder was 99.6:0.4. The solid electrolyte layer slurry was applied onto an A1 foil by a blade method, followed by drying on a hot plate at 100° C. for 30 min, to obtain a peelable solid electrolyte layer.

### 6. Production of Positive Electrode Laminated Body

The above positive electrode and the solid electrolyte layer were laminated so that the composite material surfaces overlapped. After pressing with a roll press at a pressure of 50 kN/cm and a temperature of 160° C., the Al foil was peeled from the solid electrolyte layer and punched into a size of 1 cm² to obtain a positive electrode laminated body.

### 7. Production of Negative Electrode Laminated Body

The negative electrode and the solid electrolyte layer according to Comparative Example, Example 1, or Example 2 were laminated so that the composite material surfaces overlapped. After pressing with a roll press at a pressure of 30 kN/cm and room temperature, the Al foil was peeled from the solid electrolyte layer to obtain a first laminated body. An additional solid electrolyte layer was laminated to the solid electrolyte layer side of the first laminated body to obtain a second laminated body. After the second laminated body was temporarily pressed with a planar uniaxial press at a pressure of 100 MPa and a temperature of 25° C., the Al foil was peeled from the solid electrolyte layer and punched into a size of 1.08 cm² to obtain a negative electrode laminated body having an additional solid electrolyte layer.

### 8. Production of Battery Laminated Body

The above positive electrode laminated body and negative electrode laminated body were laminated so that the composite material surfaces of the solid electrolyte layers overlapped to obtain an intermediate laminated body. The intermediate laminated body was pressed with a planar uniaxial press at a pressure of 400 MPa and a temperature of 135° C. to obtain a battery laminated body.

### 9. Restraint and Charging and Discharging of Battery Laminated Body

The battery laminated body obtained as described above was interposed between two restraining plates. The two restraining plates were fastened by a fastener with a restraining pressure of 1 MPa, and the distance between the two restraining plates was fixed. This restrained battery laminated body was subjected to constant-current charging at 1/10 C up to 4.55 V, followed by constant-voltage charging at 4.55 V to a final current of 1/100 C, and then subjected twice to constant-current discharging at 1/10 C down to 3 V; then at a constant current charging-discharging of ⅓ C from 3 V to 4.55 V; and constant-voltage charging-discharging to a final current of 1/100 C.

### 10. Resistance Measurement

After adjusting to a constant voltage at 3.7 V up to 1/100 C, the battery resistance was measured. The resistance was measured after standing in a thermostatic chamber set at 25° C. for 3 h with an electrochemical measurement device (VMP3, Biologic) at a frequency of 0.1 to 1 MHz and a voltage amplitude of 10 mV, and the impedance resistance at this time was evaluated.

### 11. Resistance Measurement after Endurance Testing

Constant-current charging and discharging at 2 C in the range of 3.14 V to 4.17 V was carried out in a 25° C. thermostatic chamber for one week, and the battery resistance was then measured in the same manner as described above. Based on the resistance value before endurance and the resistance value after endurance, the resistance increase rate was calculated from the following formula.

[Resistance increase rate]=([resistance after endurance]/[resistance before endurance])×100

### 12. Evaluation Results

Table 1 below shows the results of comparing resistance increase rates of batteries of Comparative Example and Examples 1 and 2. In Table 1 below, the resistance increase rate of the battery according to Comparative Example was set to 100, and the resistance increase rate of each of the batteries according to Examples 1 and 2 is shown relative thereto.

TABLE 1

| | Resistance increase rate |
|---|---|
| Comparative Example | 100 |
| Example 1 | 72.4 |
| Example 2 | 72.6 |

As is clear from the results shown in Table 1, when the active material composite particles according to Examples 1 and 2 were used to form the negative electrode and the battery, the resistance increase rate before and after endurance could be kept low. Specifically, it was found that the active material composite particles according to Examples 1 and 2 exhibit excellent cycle characteristics, presumably due to the following reasons.

As described above, the active material composite particles according to Examples 1 and 2 comprises a solid electrolyte in the center portion 1a. It is considered that the carrier ion-conductivity of the center portion is enhanced by including the solid electrolyte in the center portion, whereby reaction nonuniformity of Si particles in the center portion during charging and discharging is more easily suppressed, and cracking of Si particles associated with charging and discharging is more easily suppressed. As a result, excellent cycle characteristics were exhibited.

In the active material composite particles according to Examples 1 and 2, as described above, the ratio of polymer in the surface layer portion is higher than the ratio of polymer in the center portion, whereby even when Si expands due to charging, the volume change of the composite particle as a whole is moderated by the polymer in the surface layer portion, and the shape of the composite particle as a whole is easily maintained. Further, since the ratio of polymer in the surface layer is high, even when Si expands due to charging, the polymer in the surface layer portion functions as a cushioning material, and cracks and gaps in the material surrounding the composite particle are less likely to occur. As a result, excellent cycle characteristics were exhibited.

As described above, an active material composite particle comprising a center portion and a surface layer portion, wherein the center portion comprises a solid electrolyte and a plurality of Si particles, the surface layer portion comprises a polymer and has a carrier ion-conductivity, and the ratio of polymer in the surface layer portion is higher than the ratio of polymer in the center portion, has excellent cycle characteristics.

### REFERENCE SIGNS LIST

1 active material composite particle
1a center portion
   1ax solid electrolyte
   1ay Si particle
1b surface layer portion
10 positive electrode
   11 positive electrode active material layer
   12 positive electrode current collector
20 electrolyte layer
30 negative electrode
   31 negative electrode active material layer
   32 negative electrode current collector
100 secondary battery

1. An active material composite particle, comprising a center portion and a surface layer portion, wherein
the center portion comprises a solid electrolyte and a plurality of Si particles,
the surface layer portion comprises a polymer and has a carrier ion-conductivity, and
a ratio of polymer in the surface layer portion is higher than a ratio of polymer in the center portion.

2. The active material composite particle according to claim 1, wherein
carrier ion conductivity of the solid electrolyte is higher than carrier ion conductivity of the surface layer portion.

3. The active material composite particle according to claim 1, wherein
the solid electrolyte comprises a sulfide solid electrolyte.

4. The active material composite particle according to claim 1, wherein
the surface layer portion comprises a salt, and
the salt comprises a carrier ion.

5. The active material composite particle according to claim 1, wherein
a ratio of Si particles in the center portion is higher than a ratio of Si particles in the surface layer portion.

6. The active material composite particle according to claim 1, wherein
a ratio of solid electrolyte in the center portion is higher than a ratio of solid electrolyte in the surface layer portion.

7. An electrode comprising the active material composite particle according claim 1.

8. The electrode according to claim 7, comprising a solid electrolyte disposed around the active material composite particle.

9. A secondary battery, comprising a positive electrode, an electrolyte layer, and a negative electrode, wherein
the negative electrode comprises the active material composite particle according to claim 1.

10. The secondary battery according to claim 9, wherein
the negative electrode comprises a solid electrolyte disposed around the active material composite particle.

11. The secondary battery according to claim 9, wherein
the electrolyte layer comprises a solid electrolyte.

12. A manufacturing method for an active material composite particle, the method comprising:
mixing a solid electrolyte and a plurality of Si particles together to obtain an intermediate composite particle; and
coating a periphery of the intermediate composite particle with a material comprising a polymer and having a carrier ion-conductivity.
